(19) United States
(12) Patent Application Publication
(10) Pub. No.: US 2012/0310660 A1
(43) Pub. Date: Dec. 6, 2012

(54) HEALTH MONITORING SYSTEM AND METHOD FOR MONITORING HEALTH USING THE SAME

(76) Inventors: Xiangdong LIU, Wuhan (CN); Jianhuan LIU, Wuhan (CN)

(21) Appl. No.: 13/485,971

(22) Filed: Jun. 1, 2012

Related U.S. Application Data
(60) Provisional application No. 61/492,372, filed on Jun. 1, 2011.

(51) Int. Cl. G06Q 50/22

(52) U.S. Cl. 705/2

(57) ABSTRACT

Health monitoring system, including a data acquisition system, a fixed patient system, a mobile patient system, a mobile review system, a fixed review system, and a network server system. The data acquisition system includes a data hub, and a plurality of medical devices connected thereto via a communication interface, and operates to acquire medical data of a patient, and to transmit the medical data to the mobile patient system and/or the fixed patient system. The mobile patient system and the fixed patient system operate to determine whether to transmit the medical data to the mobile review system and/or the fixed review system via the network server system, or directly to the mobile review system and/or the fixed review system.

### CROSS-REFERENCE TO RELATED APPLICATIONS

This application claims the benefit of the filing date of U.S. provisional patent application Ser. No. 61/492,372, filed on Jun. 1, 2011, the disclosures of which are incorporated herein by reference.

### CORRESPONDENCE ADDRESS

Inquiries from the public to applicants or assignees concerning this document should be directed to: MATTHIAS SCHOLL P.C., ATTN.: DR. MATTHIAS SCHOLL ESQ., 14781 MEMORIAL DRIVE, SUITE 1319, HOUSTON, TX 77079.

### BACKGROUND OF THE INVENTION

1. Field of the Invention

This invention relates to a medical device field, and more particularly to a health monitoring system and a method for monitoring health using the same.

2. Description of the Related Art

Nowadays, more and more elderly people and people with chronicle disease, such as diabetes and high blood pressure, need to be monitored in terms of physiologic and health data among relevant parties of the patient such as family members, relatives, and health care providers.

Monitoring of physiologic and health data at home is not new, and many people have already had medical devices, such as blood pressure monitors, blood glucose monitors, blood cholesterol monitors, body weight scales, body temperature measurement devices, blood oxygen levels, and even ECGs available at home so as to monitor their health condition, but the monitored data are of no use without a physician's professional advice based thereon.

In the past, many health monitoring systems have been made to solve the above problem. However, there are several disadvantages with the current systems: firstly, they fail to provide a system capable of implementing real time communication between patients and relevant parties; secondly, existing systems cannot provide simultaneous multimedia communication, comprising voice, video, and image, among a wide variety of users; moreover, for different types of medical devices, data acquisition therefrom can only be facilitated by using different interfaces, which brings about great inconvenience for users; finally, the existing systems are incapable of handling complex medical data.

### SUMMARY OF THE INVENTION

In view of the above-described problems, it is an objective of the invention to provide a health monitoring system that is capable of addressing above-mentioned problems.

It is another objective of the invention to provide a method for monitoring health that is capable of addressing the above-mentioned problems.

To achieve the above objectives, in accordance with one embodiment of the invention, there is provided a health monitoring system, comprising a data acquisition system, a fixed patient system, a mobile patient system, a mobile review system, a fixed review system, and a network server system, wherein the data acquisition system comprises a data hub, and a plurality of medical devices connected thereto via a communication interface, and operates to acquire medical data of a patient, and to transmit the medical data to the mobile patient system and/or the fixed patient system, each of the mobile patient system and the fixed patient system operates to determines whether to transmit the medical data to the mobile review system and/or the fixed review system via the network server system, or directly to the mobile review system and/or the fixed review system, and to transmit the medical data to the mobile review system and/or the fixed review system if the mobile patient system and/or the fixed patient system determines to transmit the medical data to the mobile review system and/or the fixed review system, the network server system operates to receive and transmit data between the fixed patient system or the mobile patient system, and the fixed review system or the mobile review system, and the mobile review system and/or the fixed review system operates to transmit feedback data to the mobile patient system, the fixed patient system or the network server system according to the medical data, the medical data and the feedback data comprising video, audio, text, and images.

In a class of this embodiment, each of the mobile patient system and the fixed patient system comprises a first data storage module, a first destination determination module, a first synchronization module, a first registration module, a privacy setting module, a payment module, and a first instant messaging module, the first data storage module operates to receive and to save the medical data from the data acquisition system, and the feedback data from the network server system, the fixed review system, and the mobile review system, the first destination determination module operates to determine whether to transmit the medical data to the mobile review system and/or the fixed review system via the network server system, or to transmit the medical data directly to the mobile review system and/or the fixed review system, the first synchronization module 23 operates to synchronize the medical data with the network server system if the first destination determination module determines to transmit the medical data to the mobile review system and/or the fixed review system via the network server system, the first registration module operates to register information of the patient corresponding to the medical data on the network server system if the first destination determination module determines to transmit the medical data to the mobile review system and/or the fixed review system via the network server system, the first instant messaging module operates to transmit the medical data to the mobile review system and/or the fixed review system if the first destination determination module determines to directly transmit the medical data to the mobile review system and/or the fixed review system, the privacy setting module operates to sort the medical data into privacy data and non-privacy data, and to transmit the medical data to the medical data to the mobile review system and/or the fixed review system via the network server system, or the medical data directly to the mobile review system and/or the fixed review system if the medical data are non-privacy data, and to save the medical data if the medical data are privacy data, and the payment module operates to enable the patient to pay medical fee according to the feedback data.

In a class of this embodiment, each of the mobile review system and the fixed review system comprises a second data storage module, a second synchronization module, a second destination determination module, a second registration module, and a second instant messaging module, the second data storage module operates to receive and to save the medical data from the mobile patient system, the fixed patient system, and the network server system, the second destination determination module operates to determine whether to transmit the feedback data to the mobile patient system and/or the fixed patient system via the network server system, or to transmit the feedback data directly to the mobile patient system and/or the fixed patient system, the second synchronization module operates to synchronize the feedback data with the network server system if the second destination determination module determines to transmit the feedback data to the mobile patient system and/or the fixed patient system via the network server system, the second registration module operates to register information of the doctor or the medical service provider corresponding to the feedback data on the network server system if the first destination determination module determines to transmit the feedback data to the mobile patient system and/or the fixed patient system via the network server system, and the second instant messaging module operates to transmit the feedback data directly to the mobile patient system and/or the fixed patient system if the second destination determination module determines to directly transmit the medical data to the mobile review system and/or the fixed review system.

In a class of this embodiment, the mobile review system and the fixed review system are positioned on a side of a private doctor, a health care provider, or a community or a relative of the patient.

In a class of this embodiment, the mobile patient system and the mobile review system may be a mobile phone, an IPad, or a PDA, and the fixed patient system and the fixed review system may be a personal computer.

In a class of this embodiment, the communication interface is an open interface integrating RS-232 interface, USB interface, Dock, Bluetooth, Wifi, and IR.

In a class of this embodiment, the network server system comprises a user-data management module, a database module, a billing module, and a social communication module, the user-data management module operates to register information of patients, private doctors, health care providers, and communities and relatives of the patients, and to authorize registered users to use the network server system, the database module operates to save information of authorized patients, private doctors, health care providers, and communities and relatives of the patients, and to facilitate exchange of the information thereamong, the billing module operates to generate a bill according to service offered to the patient by the private doctor or the health care provider, the social communication module operates to receive and transmit data between the fixed patient system or the mobile patient system, and the fixed review system or the mobile review system, and to enable different authorized users to share with each other the medical data and feedback data.

In a class of this embodiment, at least one of the mobile review system, the fixed review system, the mobile patient system, the fixed patient system, and the network server system is equipped with an alarming module, and the alarming module operates to send alarm information as the medical data display unhealthy condition of the patient.

In a class of this embodiment, the medical devices comprise a blood pressure monitor, a blood glucose monitor, a blood cholesterol monitor, a body weight scale, a body temperature measurement device, a blood oxygen level, and an ECG.

In accordance with another embodiment of the invention, there provided is a method for monitoring health using a health monitoring system, the health monitoring system comprising a data acquisition system, a fixed patient system, a mobile patient system, a mobile review system, a fixed review system, and a network server system, and the method comprising:
acquiring medical data of a patient by the data acquisition system;
transmitting the medical data to the mobile patient system and/or the fixed patient system by the data acquisition system;
determining whether to transmit the medical data to the mobile review system and/or the fixed review system via the network server system, or to transmit the medical data directly to the mobile review system and/or the fixed review system by the mobile patient system and/or the fixed patient system;
transmitting the medical data to the mobile review system and/or the fixed review system by the network server system after saving the medical data if the mobile patient system and/or the fixed patient system determines to transmit the medical data to the mobile review system and/or the fixed review system via the network server system; and
transmitting feedback data to the mobile patient system, the fixed patient system, and/or the network server system according to the medical data by the mobile review system and/or the fixed review system.

In a class of this embodiment, the method further comprises: transmitting the medical data to the mobile review system and/or the fixed review system directly by the mobile patient system and/or the fixed patient system if the mobile patient system and/or the fixed patient system determines to transmit the medical data directly to the mobile review system and/or the fixed review system.

Advantages of the invention are summarized below:
1. the data acquisition system, the fixed patient system, the mobile patient system, the mobile review system, and the fixed review system enable the invention to implement real time communication between patients and relevant parties;
2. since the medical data and the feedback data comprise voice, data and image information, the invention can provide simultaneous multimedia communications among a wide variety of users, and thus improving application range of the invention;
3. the data hub of the invention integrates different types of communication interfaces, and therefore medical data from different medical devices can be acquired conveniently, which brings about great convenience for the users; and
4. the invention enables different private doctors, health care providers, and communities or relatives of the patient to share with each other the medical data and feedback data.

### BRIEF DESCRIPTION OF THE DRAWINGS

FIG. 1 is a block diagram of a health monitoring system in accordance with one embodiment of the invention; and

FIG. 2 is a flowchart of a method for monitoring health in accordance with another embodiment of the invention.

### DETAILED DESCRIPTION OF THE EMBODIMENTS

Detailed description of the invention will be given below in conjunction with accompanying drawings.

In the specification and claim of this application, definition of some terms is given below.

Fixed review system: a system comprising at least one non mobile device, such as a PC, connected to the Internet, and software running thereon to review health parameters of remote patients and response to the remote patient based on information reviewed.

Mobile review system: a system comprising at least one mobile computing device, such as a cellular phone, connected to a wireless communication network, and software running thereon to review remote patient health parameters and response to the remote patient based on information reviewed.

Data acquisition system: a system comprising at least a data hub to communicate with a plurality of medical device to collect patient parameters and send the parameters to the patient data system.

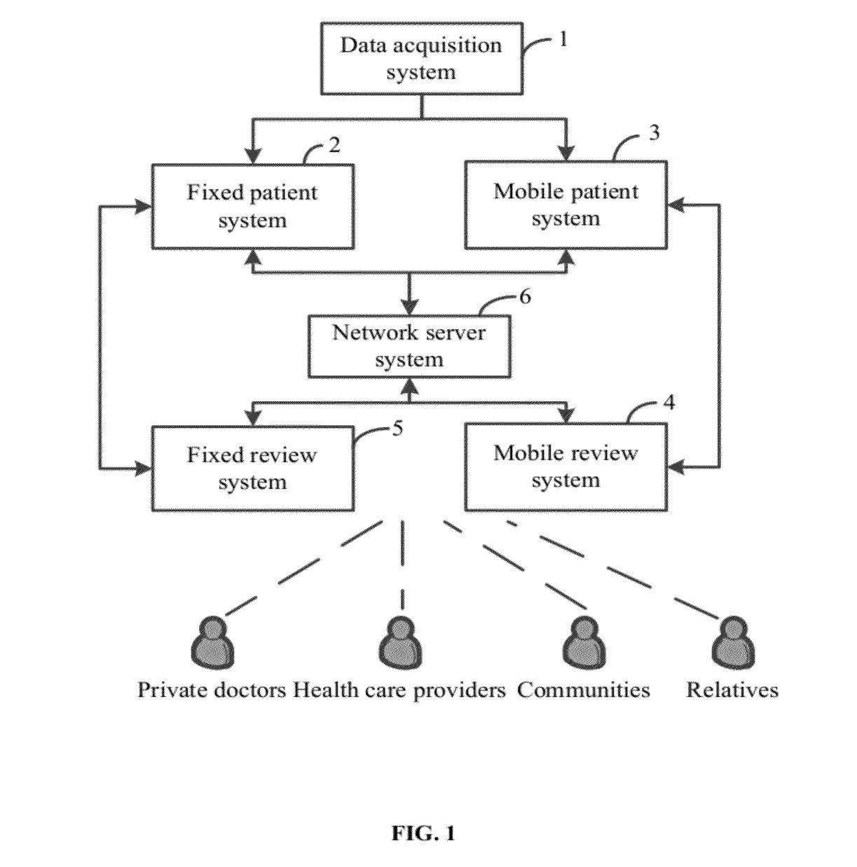

As shown in FIG. 1, a health monitoring system of one embodiment of the invention comprises a data acquisition system 1, a fixed patient system 2, a mobile patient system 3, a mobile review system 4, a fixed review system 5, and a network server system 6.

The data acquisition system 1 comprises a data hub, and a plurality of medical devices connected thereto via a communication interface, and operates to acquire medical data of a patient, and to transmit the medical data to the mobile patient system 3 and/or the fixed patient system 2. In this embodiment, the medical devices comprise a blood pressure monitor, a blood glucose monitor, a blood cholesterol monitor, a body weight scale, a body temperature measurement device, a blood oxygen level, and an ECG.

The mobile patient system 3 and/or the fixed patient system 2 operates to determines whether to transmit the medical data to the mobile review system 4 and/or the fixed review system 5 via the network server system 6, or directly to the mobile review system 4 and/or the fixed review system 5, and to transmit the medical data to the mobile review system 4 and/or the fixed review system 5 if the mobile patient system 3 and/or the fixed patient system 2 determines to transmit the medical data to the mobile review system 4 and/or the fixed review system 5.

The network server system 6 operates to receive and transmit data between the fixed patient system 2 or the mobile patient system 3, and the fixed review system 5 or the mobile review system 4.

The mobile review system 4 and/or the fixed review system 5 operates to transmit feedback data to the mobile patient system 3, the fixed patient system 2 or the network server system 6 according to the medical data, the medical data and the feedback data comprising video, audio, text and images.

Each of the mobile patient system 3 and the fixed patient system 2 comprises a first data storage module, a first destination determination module, a first synchronization module, a first registration module, a privacy setting module, a payment module, and a first instant messaging module.

The first data storage module operates to receive and to save the medical data from the data acquisition system 1, and feedback data from the network server system 6, the fixed review system 5, and the mobile review system 4.

The first destination determination module operates to determine whether to transmit the medical data to the mobile review system 4 and/or the fixed review system 5 via the network server system 6, or to transmit the medical data directly to the mobile review system 4 and/or the fixed review system 5.

The first synchronization module operates to synchronize the medical data with the network server system 6 if the first destination determination module determines to transmit the medical data to the mobile review system 4 and/or the fixed review system 5 via the network server system 6.

The first registration module operates to register information of the patient corresponding to the medical data on the network server system 6 if the first destination determination module determines to transmit the medical data to the mobile review system 4 and/or the fixed review system 5 via the network server system 6.

The first instant messaging module operates to transmit the medical data to the mobile review system 4 and/or the fixed review system 5 if the first destination determination module determines to directly transmit the medical data to the mobile review system 4 and/or the fixed review system 5.

The privacy setting module operates to sort the medical data into privacy data and non-privacy data, and to transmit the medical data to the medical data to the mobile review system 4 and/or the fixed review system 5 via the network server system 6, or the medical data directly to the mobile review system 4 and/or the fixed review system 5 if the medical data are non-privacy data, and to save the medical data if the medical data are privacy data.

The payment module operates to enable the patient to pay medical fee according to the feedback data.

Each of the mobile review system 4 and the fixed review system 5 comprises a second data storage module, a second synchronization module, a second destination determination module, a second registration module, and a second instant messaging module.

The second data storage module operates to receive and to save the medical data from the mobile patient system 3, the fixed patient system 2, and the network server system 6.

The second destination determination module operates to determine whether to transmit the feedback data to the mobile patient system 3 and/or the fixed patient system 2 via the network server system 6, or to transmit the feedback data directly to the mobile patient system 3 and/or the fixed patient system 2.

The second synchronization module operates to synchronize the feedback data with the network server system 6 if the second destination determination module determines to transmit the feedback data to the mobile patient system 3 and/or the fixed patient system 2 via the network server system 6.

The second registration module operates to register information of the doctor or the medical service provider corresponding to the feedback data on the network server system 6 if the first destination determination module determines to transmit the feedback data to the mobile patient system 3 and/or the fixed patient system 2 via the network server system 6.

The second instant messaging module operates to transmit the feedback data directly to the mobile patient system 3 and/or the fixed patient system 2 if the second destination determination module determines to directly transmit the medical data to the mobile review system 4 and/or the fixed review system 5.

The mobile review system 4 and the fixed review system 5 are positioned on a side of a private doctor, a health care provider, or a community or a relative of the patient.

In this embodiment, the mobile patient system 3 and the mobile review system 4 may be a mobile phone, an IPad, or a PDA, the fixed patient system 2 and the fixed review system 5 may be a personal computer, and the communication interface is an open interface integrating RS-232 interface, USB interface, Dock, Bluetooth, Wifi, and IR.

The network server system 6 comprises a user-data management module, a database module, a billing module, and a social communication module.

The user-data management module operates to register information of patients, private doctors, health care providers, and communities and relatives of the patients, and to authorize registered users to use the network server system 6.

The database module operates to save information of authorized patients, private doctors, health care providers, and communities and relatives of the patients, and to facilitate exchange of the information thereamong.

The billing module operates to generate a bill according to service offered to the patient by the private doctor or the health care provider.

The social communication module operates to receive and transmit data between the fixed patient system 2 or the mobile patient system 3, and the fixed review system 5 or the mobile review system 4, and to enable different authorized users to share with each other medical data and feedback data.

At least one of the mobile review system 4, the fixed review system 5, the mobile patient system 3, the fixed patient system 2, and the network server system 6 is equipped with an alarming module, and the alarming module operates to send alarm information as the medical data display unhealthy condition of the patient.

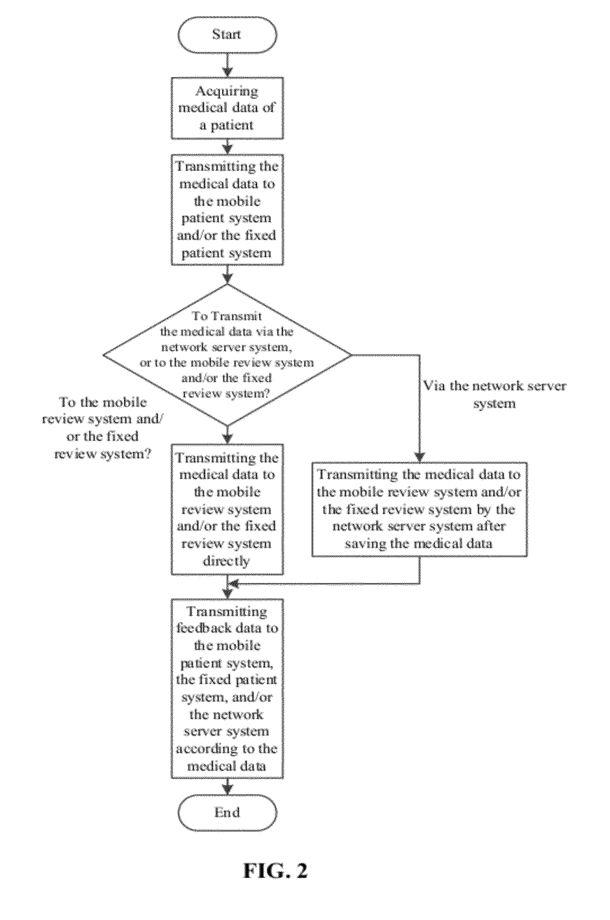

As shown in FIG. 2, a method for monitoring health in accordance with another embodiment of the invention comprises:
acquiring medical data of a patient by the data acquisition system;
transmitting the medical data to the mobile patient system and/or the fixed patient system by the data acquisition system;
determining whether to transmit the medical data to the mobile review system and/or the fixed review system via the network server system, or to transmit the medical data directly to the mobile review system and/or the fixed review system by the mobile patient system and/or the fixed patient system;
transmitting the medical data to the mobile review system and/or the fixed review system by the network server system after saving the medical data if the mobile patient system and/or the fixed patient system determines to transmit the medical data to the mobile review system and/or the fixed review system via the network server system, and transmitting the medical data to the mobile review system and/or the fixed review system directly by the mobile patient system and/or the fixed patient system if the mobile patient system and/or the fixed patient system determines to transmit the medical data directly to the mobile review system and/or the fixed review system; and
transmitting feedback data to the mobile patient system, the fixed patient system, and/or the network server system according to the medical data by the mobile review system and/or the fixed review system.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A health monitoring system, comprising:
a) a data acquisition system;
b) a fixed patient system;
c) a mobile patient system;
d) a mobile review system;
e) a fixed review system; and
f) a network server system;
wherein
said data acquisition system comprises a data hub, and a plurality of medical devices connected thereto via a communication interface, and operates to acquire medical data of a patient, and to transmit said medical data to said mobile patient system and/or said fixed patient system;
each of said mobile patient system and said fixed patient system operates to determine whether to transmit said medical data to said mobile review system and/or said fixed review system via said network server system, or directly to said mobile review system and/or said fixed review system, and to transmit said medical data to said mobile review system and/or said fixed review system if said mobile patient system and/or said fixed patient system determines to transmit said medical data to said mobile review system and/or said fixed review system;
said network server system operates to receive and transmit data between said fixed patient system or said mobile patient system, and said fixed review system or said mobile review system; and
said mobile review system and/or said fixed review system operates to transmit feedback data to said mobile patient system, said fixed patient system or said network server system according to said medical data, said medical data and said feedback data comprising video, audio, text, and images.

2. The health monitoring system of claim 1, wherein
each of said mobile patient system and said fixed patient system comprises a first data storage module, a first destination determination module, a first synchronization module, a first registration module, a privacy setting module, a payment module, and a first instant messaging module;
said first data storage module operates to receive and to save said medical data from said data acquisition system, and feedback data from said network server system, said fixed review system, and said mobile review system;
said first destination determination module operates to determine whether to transmit said medical data to said mobile review system and/or said fixed review system via said network server system, or to transmit said medical data directly to said mobile review system and/or said fixed review system;
said first synchronization module operates to synchronize said medical data with said network server system if said first destination determination module determines to transmit said medical data to said mobile review system and/or said fixed review system via said network server system;
said first registration module operates to register information of the patient corresponding to said medical data on said network server system if said first destination determination module determines to transmit said medical data to said mobile review system and/or said fixed review system via said network server system;
said first instant messaging module operates to transmit said medical data to said mobile review system and/or said fixed review system if said first destination determination module determines to directly transmit said medical data to said mobile review system and/or said fixed review system;
said privacy setting module operates to sort said medical data into privacy data and non-privacy data, and to transmit said medical data to said medical data to said mobile review system and/or said fixed review system via said network server system, or directly to said mobile review system and/or said fixed review system if said medical data are non-privacy data, and to save said medical data if said medical data are privacy data; and
said payment module operates to enable said patient to pay medical fee according to said feedback data.

3. The health monitoring system of claim 1, wherein
each of said mobile review system and said fixed review system comprises a second data storage module, a second synchronization module, a second destination determination module, a second registration module, and a second instant messaging module;
said second data storage module operates to receive and to save said medical data from said mobile patient system, said fixed patient system, and said network server system;
said second destination determination module operates to determine whether to transmit said feedback data to said mobile patient system and/or said fixed patient system via said network server system, or to transmit said feedback data directly to said mobile patient system and/or said fixed patient system;
said second synchronization module operates to synchronize said feedback data with said network server system if said second destination determination module determines to transmit said feedback data to said mobile patient system and/or said fixed patient system via said network server system;
said second registration module operates to register information of the doctor or the medical service provider corresponding to said feedback data on said network server system if said first destination determination module determines to transmit said feedback data to said mobile patient system and/or said fixed patient system via said network server system; and
said second instant messaging module operates to transmit said feedback data directly to said mobile patient system and/or said fixed patient system if said second destination determination module determines to directly transmit said medical data to said mobile review system and/or said fixed review system.

4. The health monitoring system of claim 2, wherein
each of said mobile review system and said fixed review system comprises a second data storage module, a second synchronization module, a second destination determination module, a second registration module, and a second instant messaging module;
said second data storage module operates to receive and to save said medical data from said mobile patient system, said fixed patient system, and said network server system;
said second destination determination module operates to determine whether to transmit said feedback data to said mobile patient system and/or said fixed patient system via said network server system, or to transmit said feedback data directly to said mobile patient system and/or said fixed patient system;
said second synchronization module operates to synchronize said feedback data with said network server system if said second destination determination module determines to transmit said feedback data to said mobile patient system and/or said fixed patient system via said network server system;
said second registration module operates to register information of the doctor or the medical service provider corresponding to said feedback data on said network server system if said first destination determination module determines to transmit said feedback data to said mobile patient system and/or said fixed patient system via said network server system; and
said second instant messaging module operates to transmit said feedback data directly to said mobile patient system and/or said fixed patient system if said second destination determination module determines to directly transmit said medical data to said mobile review system and/or said fixed review system.

5. The health monitoring system of claim 1, wherein said mobile review system and said fixed review system are positioned on a side of a private doctor, a health care provider, or a community or a relative of said patient.

6. The health monitoring system of claim 1, wherein said mobile patient system and said mobile review system may be a mobile phone, an IPad, or a PDA, and said fixed patient system and said fixed review system may be a personal computer.

7. The health monitoring system of claim 1, wherein said communication interface is an open interface integrating RS-232 interface, USB interface, Dock, Bluetooth, Wifi, and IR.

8. The health monitoring system of claim 1, wherein
said network server system comprises a user-data management module, a database module, a billing module, and a social communication module;
said user-data management module operates to register information of patients, private doctors, health care providers, and communities and relatives of said patients, and to authorize registered users to use said network server system;
said database module operates to save information of authorized patients, private doctors, health care providers, and communities and relatives of said patients, and to facilitate exchange of said information thereamong;
said billing module operates to generate a bill according to service offered to said patient by said private doctor or said health care provider; and
said social communication module operates to receive and transmit data between said fixed patient system or said mobile patient system, and said fixed review system or said mobile review system, and to enable different authorized users to share with each other medical data and feedback data.

9. The health monitoring system of claim 2, wherein
said network server system comprises a user-data management module, a database module, a billing module, and a social communication module;
said user-data management module operates to register information of patients, private doctors, health care providers, and communities and relatives of said patients, and to authorize registered users to use said network server system;
said database module operates to save information of authorized patients, private doctors, health care providers, and communities and relatives of said patients, and to facilitate exchange of said information thereamong;
said billing module operates to generate a bill according to service offered to said patient by said private doctor or said health care provider; and
said social communication module operates to receive and transmit data between said fixed patient system or said mobile patient system, and said fixed review system or said mobile review system, and to enable different authorized users to share with each other medical data and feedback data.

10. The health monitoring system of claim 5, wherein
said network server system comprises a user-data management module, a database module, a billing module, and a social communication module;
said user-data management module operates to register information of patients, private doctors, health care providers, and communities and relatives of said patients, and to authorize registered users to use said network server system;
said database module operates to save information of authorized patients, private doctors, health care providers, and communities and relatives of said patients, and to facilitate exchange of said information thereamong;
said billing module operates to generate a bill according to service offered to said patient by said private doctor or said health care provider; and
said social communication module operates to receive and transmit data between said fixed patient system or said mobile patient system, and said fixed review system or said mobile review system, and to enable different authorized users to share with each other medical data and feedback data.

11. The health monitoring system of claim 1, wherein at least one of said mobile review system, said fixed review system, said mobile patient system, said fixed patient system, and said network server system is equipped with an alarming module, and said alarming module operates to send alarm information as said medical data display unhealthy condition of said patient.

12. The health monitoring system of claim 1, wherein said medical devices comprise a blood pressure monitor, a blood glucose monitor, a blood cholesterol monitor, a body weight scale, a body temperature measurement device, a blood oxygen level, and an ECG.

13. A method for monitoring health using a health monitoring system, said system comprising a data acquisition system, a fixed patient system, a mobile patient system, a mobile review system, a fixed review system, and a network server system, and said method comprising:
a) acquiring medical data of a patient by said data acquisition system;
b) transmitting said medical data to said mobile patient system and/or said fixed patient system by said data acquisition system;
c) determining whether to transmit said medical data to said mobile review system and/or said fixed review system via said network server system, or to transmit said medical data directly to said mobile review system and/or said fixed review system by said mobile patient system and/or said fixed patient system;
d) transmitting said medical data to said mobile review system and/or said fixed review system by said network server system after saving said medical data if said mobile patient system and/or said fixed patient system determines to transmit said medical data to said mobile review system and/or said fixed review system via said network server system; and
e) transmitting feedback data to said mobile patient system, said fixed patient system, and/or said network server system according to said medical data by said mobile review system and/or said fixed review system.

14. The method of claim 13, further comprising: transmitting said medical data to said mobile review system and/or said fixed review system directly by said mobile patient system and/or said fixed patient system if said mobile patient system and/or said fixed patient system determines to transmit said medical data directly to said mobile review system and/or said fixed review system.
